(19) United States
(12) Patent Application Publication
(10) Pub. No.: US 2019/0303878 A1
(43) Pub. Date: Oct. 3, 2019

(54) COGNITIVE MEETING SCHEDULING SYSTEM

(71) Applicant: INTERNATIONAL BUSINESS MACHINES CORPORATION, ARMONK, NY (US)

(72) Inventors: Aly MEGAHED, San Jose, CA (US); Hamid Reza MOTAHARI NEZHAD, San Jose, CA (US); Peifeng YIN, San Jose, CA (US)

(21) Appl. No.: 15/941,513

(22) Filed: Mar. 30, 2018

(51) Int. Cl. G06Q 10/10

(52) U.S. Cl. CPC G06Q 10/1095; G06F 7/026

(57) ABSTRACT

A meeting scheduling system may include a processor and a memory cooperating therewith. The processor may be configured to obtain meeting attributes for a meeting to be scheduled including attributes of desired meeting participants, attributes about meetings already scheduled for the desired meeting participants, attributes of meetings already conducted, and attributes of communications by the desired meeting participants. The processor may also be configured to classify the meeting to be scheduled by determining respective probabilities of whether the meeting will be held, cancelled, or rescheduled based upon the meeting attributes and present, to a meeting scheduler, potential time slots for the meeting to be scheduled based upon the classifying. The processor may also determine, based upon selection by the meeting scheduler, a selected time slot from among the potential time slots and present, to each desired meeting participant, the selected time slot.

### BACKGROUND

The present invention relates to computer systems, and more specifically, to electronic meeting scheduling.

In today's business world, a person may be requested to attend several meetings in a given workday. More particularly, a desired meeting participant may receive more than one meeting request for any given day and for any given time slot.

Typically, when a meeting request is received, the meeting request is either, for example, by way of a meeting schedule, accepted, declined, or another time slot and/or day is suggested. Whether a meeting request is accepted, declined, or another time slot and/or day is suggested may be determined based upon the respective desired meeting participant's calendar, for example, based upon already scheduled meetings and/or the priority of the proposed and/or scheduled meetings.

### SUMMARY

A meeting scheduling system may include a processor and a memory cooperating therewith. The processor may be configured to obtain a plurality of meeting attributes for a meeting to be scheduled including attributes of desired meeting participants, attributes about meetings already scheduled for the desired meeting participants, attributes of meetings already conducted, and attributes of communications by the desired meeting participants. The processor may be configured to classify the meeting to be scheduled by determining respective probabilities of whether the meeting will be held, cancelled, or rescheduled based upon the plurality of meeting attributes and present, to a meeting scheduler, a plurality of potential time slots for the meeting to be scheduled based upon the classifying. The processor may also be configured to determine, based upon selection by the meeting scheduler, a selected time slot from among the plurality of potential time slots.

The processor may be configured to present, to a desired meeting participant, a probability that the meeting will be held, cancelled, or rescheduled. The processor may also be configured to present, to each desired meeting participant, the selected time slot, for example.

The processor may include a machine learning classifier configured to classify the meeting to be scheduled and to be trained based upon the plurality of meeting attributes. The processor may be configured to rank the plurality of potential time slots, for example.

The processor may be configured to rank the plurality of time slots based upon a probability of desired meeting participants being available. The processor may be configured to run an optimization model on the ranked plurality of time slots.

The optimization model may be configured to increase a probability that meetings with a higher priority will held. The processor may be configured to assign a priority based upon at least one of a meeting attribute of priority and a calculation of priority from the plurality of meeting attributes, for example.

The processor may be configured to present, to the meeting scheduler, a respective probability of each desired meeting participant being available at the selected time slot. The processor may be configured to calculate a respective joint probability each potential time slot is available based upon the respective determined probabilities of a meeting at corresponding time slots being cancelled or rescheduled.

The attributes of desired meeting participants may include at least one of participant identification, whether a desired meeting participant is required for the meeting, and whether the desired meeting participant is optional for the meeting, for example. The attributes of meetings already conducted for the desired meeting participants may include date and time of the meetings already conducted, meeting participants at the meetings already conducted, a classification of whether the meetings already conducted were held as originally scheduled, cancelled, or rescheduled, for example. The plurality of meeting attributes may include unstructured data.

A method aspect is directed to a method of scheduling a meeting. The method may include using a processor and memory cooperating therewith to obtain a plurality of meeting attributes for a meeting to be scheduled including attributes of desired meeting participants, attributes about meetings already scheduled for the desired meeting participants, attributes of meetings already conducted, and attributes of communications by the desired meeting participants. The method may also include using the processor to classify the meeting to be scheduled by determining respective probabilities of whether the meeting will be held, cancelled, or rescheduled based upon the plurality of meeting attributes and present, to a meeting scheduler, a plurality of potential time slots for the meeting to be scheduled based upon the classifying. The method may also include using the processor to determine, based upon selection by the meeting scheduler, a selected time slot from among the plurality of potential time slots.

A computer readable medium aspect is directed to a computer readable medium for a meeting scheduling system that includes computer executable instructions that when executed by a processor of the meeting scheduling system causes the processor to perform operations. The operations may include obtaining a plurality of meeting attributes for a meeting to be scheduled including attributes of desired meeting participants, attributes about meetings already scheduled for the desired meeting participants, attributes of meetings already conducted, and attributes of communications by the desired meeting participants. The operations may also include classifying the meeting to be scheduled by determining respective probabilities of whether the meeting will be held, cancelled, or rescheduled based upon the plurality of meeting attributes and presenting, to a meeting scheduler, a plurality of potential time slots for the meeting to be scheduled based upon the classifying. The operations may also include determining, based upon selection by the meeting scheduler, a selected time slot from among the plurality of potential time slots.

### BRIEF DESCRIPTION OF THE DRAWINGS

FIG. 1 is a schematic diagram of a meeting scheduling system according to an embodiment.

FIG. 2 is a more detailed schematic diagram of the meeting scheduling system of FIG. 1.

FIG. 3 is a flow diagram of operation of the meeting scheduling system of FIG. 1.

FIG. 4 is a schematic diagram of operation of a meeting scheduling system with respect to inputs and outputs in accordance with an embodiment.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

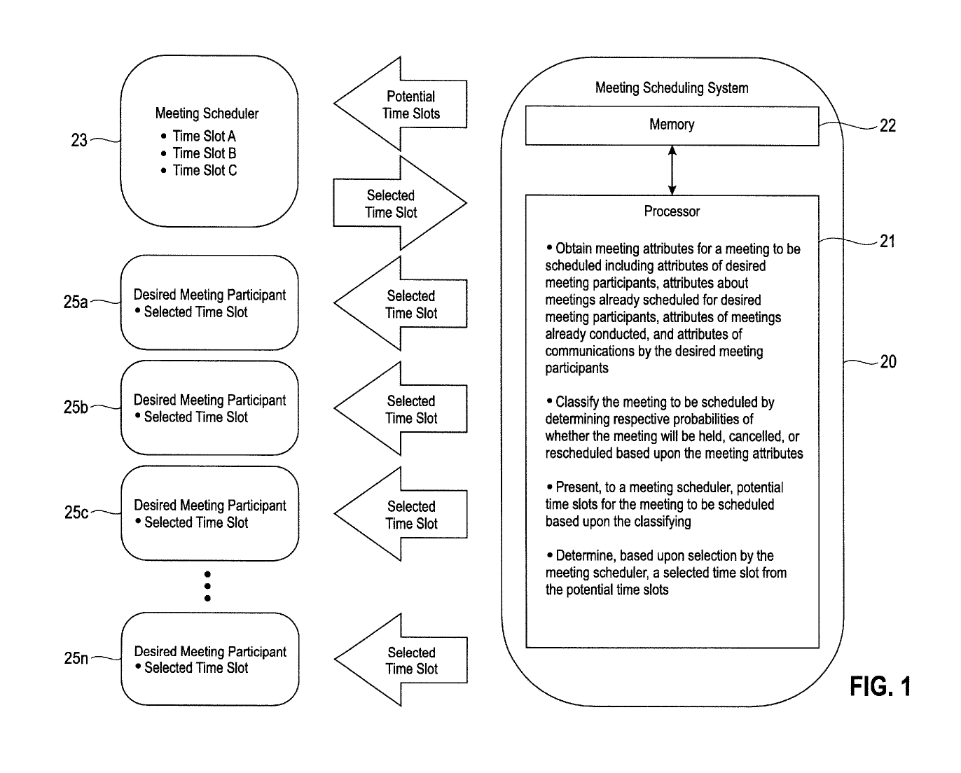

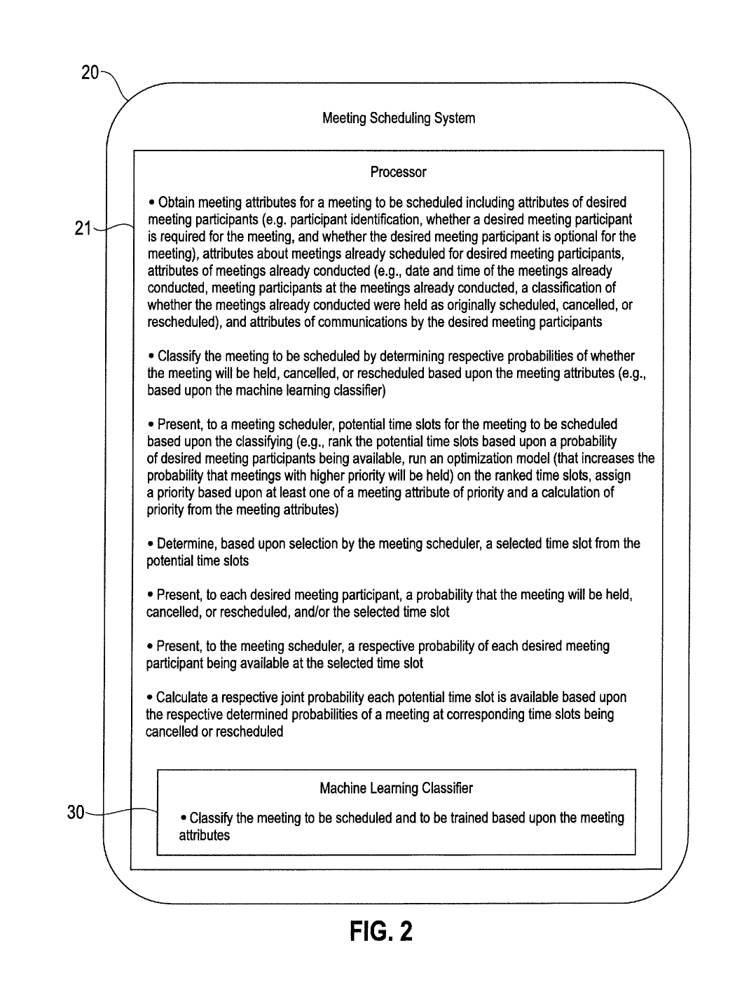

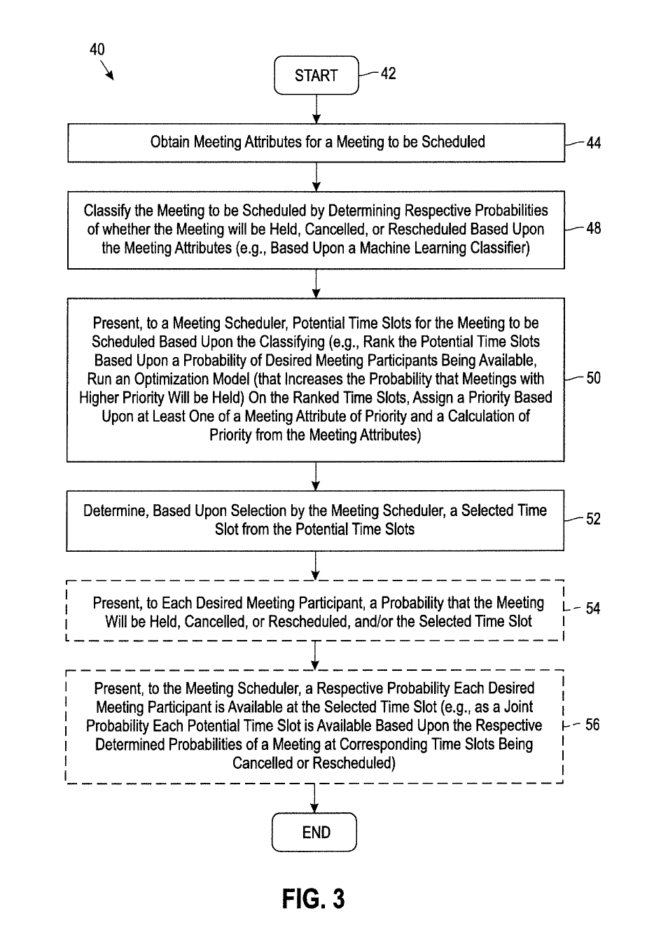

Referring initially to FIGS. 1 and 2, and the flow chart 40 in FIG. 3, beginning at Block 42, a meeting scheduling system 20 and its operation will now be described. The meeting scheduling system 20 illustratively includes a processor 21 and a memory 22 cooperating therewith. The processor 21 is configured to, at Block 44, obtain a plurality of meeting attributes for a meeting to be scheduled. The meeting attributes include attributes of desired meeting participants. The attributes of desired meeting participants may include at least one of participant identification (e.g., name, email, title within an organization, etc.), whether a desired meeting participant is required for the meeting, and whether the desired meeting participant is optional for the meeting. Of course, the attributes of desired meeting participants may include other and/or additional attributes.

The meeting attributes also include attributes about meetings already scheduled for the desired meeting participants 25a-25n. Attributes of meetings already scheduled may include dates and times of scheduled meetings either or both of scheduled or tentative. The attributes may also include participants of the scheduled meetings and/or their respective locations. Of course, the attribute of meetings already scheduled may include other and/or additional attributes.

The meeting attributes also include attributes of meetings already conducted 25a-25n. The attributes of meetings already conducted for the desired meeting participants 25a-25n may include a date and time of the meetings already conducted, meeting participants at the meetings already conducted, and a classification of whether the meetings already conducted were held as originally scheduled, cancelled, or rescheduled. Of course, the attributes of meetings already conducted may include other and/or additional attributes. The attributes of meetings already conducted may be for desired meeting participants and/or others that are not desired meeting participants.

The meeting attributes further include attributes of communications by the desired meeting participants 25a-25n. Communications by the desired meeting participants 25a-25n may include emails, instant messages, social media messages, communications between desired participants and/or communications about meetings (past and/or scheduled), and/or other types of electronic communications (i.e., unstructured data). Of course, the attributes of communications by the desired meeting participants 25a-25n may include other and/or additional attributes.

The processor 21, at Block 48, classifies the meeting to be scheduled by determining respective probabilities of whether the meeting will be held, cancelled, or rescheduled based upon the meeting attributes. More particularly, the processor 21 includes or operates a machine learning classifier 30 that classifies the meeting to be scheduled and is to be trained based upon the attributes of meetings already scheduled, and, thus, the processor classifies the meeting to be scheduled based upon the machine learning classifier.

The processor 21 also presents, to a meeting scheduler 23, for example, using a meeting scheduler computer, potential time slots for the meeting to be scheduled based upon the classifying (Block 50). More particularly, the processor 21 may rank the potential time slots. The potential time slots may be ranked based upon a probability of desired meeting participants being available. An optimization model, executed by the processor 21 may be run on the ranked time slots. The optimization model increases the probability that meetings with higher priority will be held. The processor 21 may thus assign a priority based upon (e.g., to be) one or more of the meeting attributes and a calculation of priority from the meeting attributes. In other words, the optimization model provides increased weight to more important meetings. Of course, if all meetings to be held have a relatively high probability of being held, the optimization model will provide an output indicative of such. However, this is typically not the case (as there are trade-offs and thus the optimization model is desired), as the model provides higher priority to more important meetings.

The processor 21 determines, based upon selection by the meeting scheduler 23, a selected time slot from among the plurality of potential time slots (Block 52). In some embodiments, the processor 21 may also present, to each desired meeting participant 25a-25n, for example, at respective participant computers (e.g., a PC, tablet, and/or mobile wireless communications device), a probability that the meeting will be held, cancelled, or rescheduled along with the selected time slot (Block 54).

In some embodiments, the processor 21 may present, to the meeting scheduler, a respective probability of each desired meeting participant 25a-25n being available at the selected time slot (Block 56). The probability may be calculated as a respective joint probability that each potential time slot is available based upon the respective determined probabilities of a meeting at corresponding time slots being cancelled or rescheduled, for example. The method ends at Block 58.

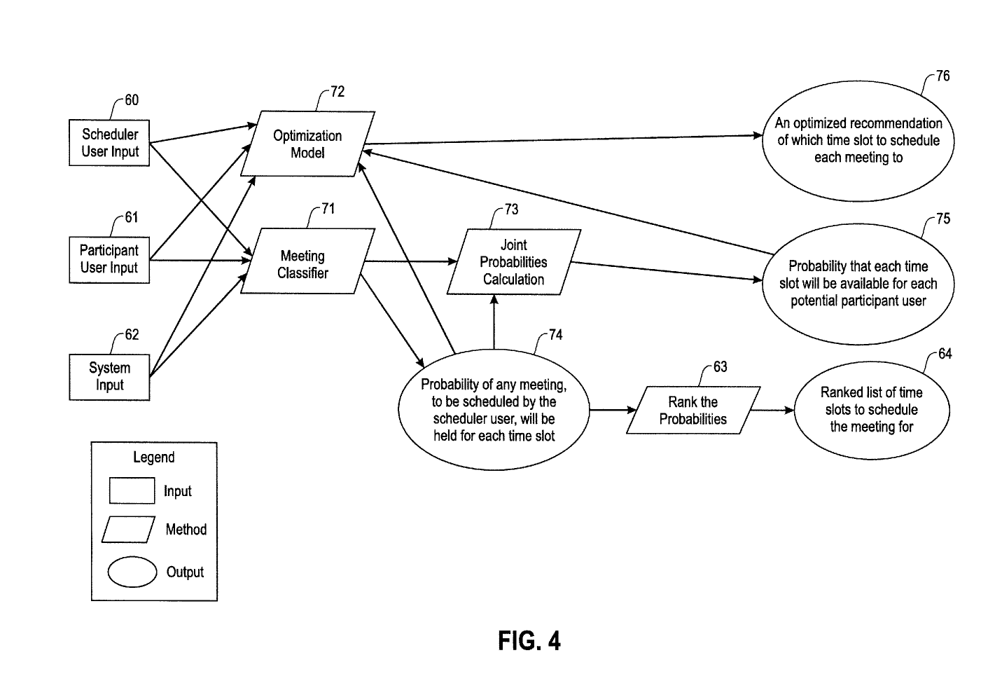

Referring now additionally to the diagram in FIG. 4, further details of the meeting scheduling system 20 will now be described with respect to inputs, operations, and outputs. In particular, the meeting scheduling system 20 will be now be described with respect to inputs. One type of input includes inputs by a scheduler user (Block 60). These inputs include attributes of the meeting such as user IDs of the participants of the meetings that need to be scheduled. It should be noted that it is being assumed that the scheduler user has multiple meetings that he or she wants to schedule. That user might be an administrator of some group for example. Another scheduler user input includes which participants are “must have/required” and which are “nice to have/optional.” The scheduler user also provides a user-defined target time frame and the priority of each meeting or optionally a user-defined function to compute the priority from attributes of the meeting.

The meeting scheduling system 20 also accepts participant user inputs (Block 61). Participant user inputs include timing and participants of coming meeting request, and participant user ID.

The meeting scheduling system 20 also accepts system inputs (Block 62). System inputs include records of historical meetings: when, actual participant user IDs (participants that did attend the meetings), invited participant user IDs (invited participants that may or may not have attended the meetings), where, and whether the meeting was held, rescheduled, or cancelled, etc. (any other relevant meta-data describing meeting features).

Optionally, each meeting may have an importance rating for each of its participants provided by that participant. The importance rating may be 1 to 5, where 5 is “very important” and 1 is “can be skipped”. Users may provide an importance rating for each meeting that they accept after they accept it. In another embodiment, “1” flag may be used instead of 1 to 5 ratings, where a meeting for any participant is flagged as “1” if that participant accepted it, “0” otherwise. Current (and future up to the maximum deadline D1 of the scheduler user-defined target time frame) meetings data for all user IDs with their importance rating which can be computed by looking at which meeting the participant attended in case of multiple bookings, provided explicitly by the user is also provided as an input. Still further, historical unstructured data of communications about meetings is provided as an input.

The meeting scheduling system 20 will now be described with respect to outputs. With respect to a scheduler user, the system 20 ranks probabilities (Block 63) outputs a ranked list of time slots to schedule the meeting for (Block 64), along with the corresponding joint probability of availability for the participants (Block 75). These time slots fulfil the constraints inputted by the scheduler user. An optimized recommendation of which time slot to schedule each meeting is also outputted by the system 20 (Block 76).

With respect to a participant user, the meeting scheduling system 20 outputs a probability that the coming meeting will be cancelled or rescheduled (e.g., this may be computed based on a machine learning (ML) model 1) (Block 74). The meeting scheduling system 20 also outputs, with respect to a participant user, a joint probability that the already booked meetings, in that time slot of the coming meeting, will be cancelled or rescheduled. This is the probability that this time slot will be available for the user. This may be calculated as the multiplication of the probabilities of the rescheduling or cancelling currently scheduled meetings (assuming that they are independent), for example. These latter probabilities may be calculated using an ML model 1 as well.

Further details of meeting classification, by way of the meeting classifier aspect of the processor 21 will now be described. The meeting classifier (Block 71) (Classifier 1) classifies any meeting whether it will be held, rescheduled, or cancelled, based on historical structured and unstructured data. Using the meeting classifier, for any time slot, the probability that this time slot will be available can be calculated, that is, the probability that all the meetings in it will be rescheduled or cancelled assuming independence between meetings. This latter probability is generally different for each user, as will be appreciated by those skilled in the art.

With respect to meeting prioritization, for the scheduler user, if the priority of the meeting is not given, the priority of each of the meetings the user wants to schedule based on a user defined function that takes an input of attributes assigned to each meeting and based on analyzing the structured data about that meeting is calculated. Unstructured data, for example, videos, photos, emails, text messages, etc., may also be analyzed. The output is a relative weight for each of these meetings. Such weight could be between 0 and 1, for example.

With respect to a time slot recommendation to schedule meetings, the optimization model (Block 72) schedules the meetings at hand for the scheduler user. The optimization model assigns the meetings to the available time slots depending on the weights of these meetings as well as the probabilities of the slots being available (Block 76). These probabilities are calculated as the joint probability (Block 73) of the probabilities of that slot being available for each participant of the participants of that meeting (Block 75). The objective function of the model assigns meetings with high weights to slots with high probability of being available as much as possible. Accordingly, the overall objective may thus be to maximize the utility of scheduling meetings with high priority/weights.

With respect to obtaining an output for a participant user, the system 20 assigns that user the probability that the coming meeting will be held or not (rescheduled or cancelled) as well as the probability of its time slot being available for that user (Block 74). This function takes in account a number of indicators, for example, whether the user has vacation planner or vacation notification, whether linguistically the user sent a reply to another invite in that day/time frame of this time slot saying that he will be unavailable next week. A probability for the required users separate from optional ones may be assigned.

As will be appreciated by those skilled in the art, in today's business world, overbooking may be increasingly problematic. For example, a given user may receive more than one meeting request at a same time slot. Typically, the given user would request rescheduling of less important meetings, or for example, try to reschedule the meetings with participants who are lower in their managerial chain. Similarly, from the meeting scheduling prospective, it may be increasingly challenging to find time slots that are open for all required participants of the meeting. Calendars are typically either blocked or available, and there may be no way for a meeting scheduler to understand/tell the chance of being able to hold the meeting at any time slot that looks unavailable.

An example application context may be scheduling deal review meetings, where there are multiple projects/deals to be reviewed and there is a pool of people to include with different roles and expertise. The environment may be considered very dynamic in the sense that it is not unlikely that a lot of meetings get moved for multiple factors. Finding one time slot in the near horizon (e.g., in the next week) for which everyone is vacant may sometimes be or seem impossible. Thus, the meeting scheduling system 20, as a cognitive approach, provides increased utilization of time and resources, for example, based upon analytics to manage such scheduling. Typical prior art scheduling systems do not rely on unstructured data, and thus the present system 20 operates in an unconventional manner using unstructured data.

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks. The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A meeting scheduling system comprising:
a processor and a memory cooperating therewith, the processor configured to
obtain a plurality of meeting attributes for a meeting to be scheduled comprising attributes of desired meeting participants, attributes about meetings already scheduled for the desired meeting participants, attributes of meetings already conducted, and attributes of communications by the desired meeting participants,
classify the meeting to be scheduled by determining respective probabilities of whether the meeting will be held, cancelled, or rescheduled based upon the plurality of meeting attributes,
present, to a meeting scheduler, a plurality of potential time slots for the meeting to be scheduled based upon the classifying, and
determine, based upon selection by the meeting scheduler, a selected time slot from among the plurality of potential time slots.

2. The meeting scheduling system of claim 1 wherein the processor is configured to present, to a desired meeting participant, a probability that the meeting will be held, cancelled, or rescheduled.

3. The meeting scheduling system of claim 1 wherein the processor is configured to present, to each desired meeting participant, the selected time slot.

4. The meeting scheduling system of claim 1 wherein the processor comprises a machine learning classifier configured to classify the meeting to be scheduled and to be trained based upon the plurality of meeting attributes.

5. The meeting scheduling system of claim 1 wherein the processor is configured to rank the plurality of potential time slots.

6. The meeting scheduling system of claim 5 wherein the processor is configured to rank the plurality of time slots based upon a probability of desired meeting participants being available.

7. The meeting scheduling system of claim 5 wherein the processor is configured to run an optimization model on the ranked plurality of time slots.

8. The meeting scheduling system of claim 7 wherein the optimization model is configured to increase a probability that meetings with a higher priority will held.

9. The meeting scheduling system of claim 8 wherein the processor is configured to assign a priority based upon at least one of a meeting attribute of priority and a calculation of priority from the plurality of meeting attributes.

10. The meeting scheduling system of claim 1 wherein the processor is configured to present, to the meeting scheduler, a respective probability of each desired meeting participant being available at the selected time slot.

11. The meeting scheduling system of claim 1 wherein the processor is configured to calculate a joint respective probability each potential time slot is available based upon the respective determined probabilities of a meeting at corresponding time slots being cancelled or rescheduled.

12. The meeting scheduling system of claim 1 wherein the attributes of desired meeting participants comprise at least one of participant identification, whether a desired meeting participant is required for the meeting, and whether the desired meeting participant is optional for the meeting.

13. The meeting scheduling system of claim 1 wherein the attributes of meetings already conducted for the desired meeting participants comprise date and time of the meetings already conducted, meeting participants at the meetings already conducted, and a classification of whether the meetings already conducted were held as originally scheduled, cancelled, or rescheduled.

14. The meeting scheduling system of claim 1 wherein the plurality of meeting attributes comprises unstructured data.

15. A method of scheduling a meeting comprising:
using a processor and memory cooperating therewith to
obtain a plurality of meeting attributes for a meeting to be scheduled comprising attributes of desired meeting participants, attributes about meetings already scheduled for the desired meeting participants, attributes of meetings already conducted, and attributes of communications by the desired meeting participants,
classify the meeting to be scheduled by determining respective probabilities of whether the meeting will be held, cancelled, or rescheduled based upon the plurality of meeting attributes,
present, to a meeting scheduler, a plurality of potential time slots for the meeting to be scheduled based upon the classifying, and
determine, based upon selection by the meeting scheduler, a selected time slot from among the plurality of potential time slots.

16. The method of claim 15 wherein using the processor comprises using the processor to present, to a desired meeting participant, a probability that the meeting will be held, cancelled, or rescheduled.

17. The method of claim 15 wherein using the processor comprises using the processor to present, to each desired meeting participant, the selected time slot.

18. The method of claim 15 wherein the processor comprises a machine learning classifier configured to classify the meeting to be scheduled and to be trained based upon the plurality of meeting attributes.

19. A computer readable medium for a meeting scheduling system comprising computer executable instructions that when executed by a processor of the meeting scheduling system causes the processor to perform operations comprising:
obtaining a plurality of meeting attributes for a meeting to be scheduled comprising attributes of desired meeting participants, attributes about meetings already scheduled for the desired meeting participants, attributes of meetings already conducted, and attributes of communications by the desired meeting participants;
classifying the meeting to be scheduled by determining respective probabilities of whether the meeting will be held, cancelled, or rescheduled based upon the plurality of meeting attributes;
presenting, to a meeting scheduler, a plurality of potential time slots for the meeting to be scheduled based upon the classifying; and
determining, based upon selection by the meeting scheduler, a selected time slot from among the plurality of potential time slots.

20. The computer readable medium of claim 19 wherein the operations comprise presenting, to a desired meeting participant, a probability that the meeting will be held, cancelled, or rescheduled.

21. The computer readable medium of claim 19 wherein the operations comprise presenting, to each desired recipient, the selected time slot.

22. The computer readable medium of claim 19 wherein the processor comprises a machine learning classifier configured to classify the meeting to be scheduled and to be trained based upon the plurality of meeting attributes.
